(19) United States
(12) Patent Application Publication
(10) Pub. No.: US 2004/0019146 A1
(43) Pub. Date: Jan. 29, 2004

(54) Elastomeric polyurethane fiber with high heat-set efficiency

(76) Inventors: Hiroshi Nishikawa, Otsu, Shiga (JP); Toshihiro Tanaka, Otsu, Shiga (JP); Tomoharu Ima, Otsu, Shiga (JP); Masahito Inoue, Otsu, Shiga (JP)

Correspondence Address: Robert B Furr, E I du Pont de Nemours and Company, Legal- Patents, 4417 Lancaster Pike, Wilmington, DE, 19898, US

(21) Appl. No.: 10/432,207

(22) PCT Filed: Dec. 20, 2001
(86) PCT No.: PCT/US01/50772

(30) Foreign Application Priority Data
Dec. 20, 2000 (JP) 2000-386746
Dec. 20, 2000 (JP) 2000-386745

(51) Int. Cl. C08J 3/00

(52) U.S. Cl. 524/507

(57) ABSTRACT

The invention provides an elastomeric polyurethane fiber including at least one polymeric additive selected from the group consisting of poly(vinylalcohol), modified poly(acrylic acid) and copolymers thereof.

### BACKGROUND OF THE INVENTION

1. Field of the Invention

The present invention relates to an elastomeric polyurethane fiber having selected polymeric additives therein. More particularly, the invention relates to such a fiber wherein the polymeric additives are poly(vinyl alcohol), modified poly(acrylic acid), or copolymers thereof.

2. Description of Background Art

Fabrics or yams which contain elastomeric polyurethane fiber either ‘bare’ or in combination with non-elastomeric fibers are typically heat-set to provide the fabric or yarn with good dimensional stability, to shape and size the finished garment, and for other purposes such as ease of donning and doffing of high polyurethane fiber-content apparel. Typical heat-setting temperatures used in commercial operations are 195° C. for 6,6-nylon, 190° C. for 6-nylon, and 180° C. for cotton. The relatively low temperatures suitable for fibers such as cotton put certain demands on the polyurethane fiber. For example, if the polyurethane fiber has an acceptable heat-set efficiency only at temperatures used for the nylons, it cannot be heat-set in a fabric containing cotton, which will be damaged by exposure to such higher temperatures.

Various means have been used to improve the heat-set efficiency of polyurethane fiber, for example as disclosed in International Published Patent Application WO2000-11246, and in U.S. patents U.S. Pat. No. 5,800,920, U.S. Pat. No. 5,539,037, U.S. Pat. No. 4,973,647, and U.S. Pat. No. 5,000,899.

Various means have also been used to improve the whiteness retention of polyurethane fiber, including incorporating polymeric additives such as a copolymer of diisopropylaminoethyl methacrylate and n-decyl methacrylate as disclosed in U.S. patents U.S. Pat. No. 3,428,711 and a condensation polymer of p-cresol and divinyl benzene, as disclosed in U.S. patent U.S. Pat. No. 3,553,290.

The comfort of clothing may be improved under conditions of high humidity by increasing the moisture absorption-desorption characteristics of the fibers of which the clothing is comprised. Similarly, under conditions of low humidity, the tendency of certain fibers to cling to the body due to static electricity can be reduced by increasing the moisture absorption characteristics of the fibers.

Japanese Patent Application Publication JP2000144532 discloses a method of incorporating a polyethylene glycol-based polyurethane into polyurethane fiber. Japanese Patent Application Publication JP09041204 discloses high moisture absorption-desorption biconstituent polyetheresteramide/polyamide fibers that can be combined with polyurethane fiber in downstream processing.

However, the elastomeric polyurethane fibers disclosed in the prior art do not simultaneously provide good heat-set efficiency and moisture absorption-desorption and whiteness retention, and an improved polyurethane fiber is still needed.

### SUMMARY OF THE INVENTION

The present invention provides an elastomeric polyurethane fiber containing a polymeric additive having repeat units and selected from the group consisting of:

poly(vinyl alcohol) and copolymers thereof, wherein at least about 1 mole % of the repeat units derived from vinyl acetate have hydroxyl groups, and at most about 99 mole % of the repeat units derived from vinyl acetate have hydroxyl groups; and

modified poly(acrylic acid) and copolymers thereof, wherein acidic hydrogens in at least about 40 mole % of the repeat units derived from acrylic acid have been replaced with substantially non-acidic moieties; wherein the additive is present in the fiber at a level of at least about 0.5 wt % based on the weight of the fiber, and the additive is present in the fiber at a level of at most about 50 wt %, based on the weight of the fiber.

The invention also provides a process for making such an elastomeric polyurethane fiber, comprising the steps of contacting a polymeric glycol with a diisocyanate to form a capped glycol, dissolving the capped glycol in a solvent, reacting the dissolved capped glycol with a chain extender to form the polyurethane in solution, adding the polymeric additive to the polyurethane solution, solution-spinning the polyurethane solution to form the fiber and collecting the fiber, particularly such a process wherein when the polymeric additive is poly(acrylic acid) or a copolymer thereof, and monoamine chain terminator is added to the polyurethane solution in an amount of at least about 40 mole % of the acid repeat units in the additive.

### DETAILED DESCRIPTION OF THE INVENTION

It has now been found that elastomeric polyurethane fiber containing selected polymeric additives has an unexpectedly high combination of good heat-set efficiency, high moisture absorption-desorption, and resistance to yellowing (“whiteness retention”).

As used herein, “elastomeric polyurethane fiber” and “polyurethane fiber” mean a staple fiber or continuous filament comprising polyurethane and which, free of diluents, has a break elongation in excess of 100% independent of any crimp and which when stretched to twice its length, held for one minute, and then released, retracts to less than 1.5 times its original length within one minute of being released. Spandex is an is example of such a fiber. “Modified poly(acrylic acid)” means a poly(acrylic acid) wherein in at least about 40 mole % of the repeat units, the acidic hydrogens have been replaced with a non-acidic moiety, for example a metal ion or an (alkyl)ammonium ion.

The elastomeric polyurethane fiber of the invention contains a polymeric additive selected from the group consisting of poly(vinyl alcohol), modified poly(acrylic acid), and copolymers thereof.

To ease the dispersion and dissolution of the polymeric additive in the polyurethane spinning solution, to gain good optical clarity of the polyurethane fiber, and to improve the whiteness retention of the polyurethane fiber, which might be affected if the amount of the polymeric additive in the fiber were to decrease during the spinning process, it is preferred that the polymeric additive have a selected range of solution viscosities and number average molecular weights. When the polymeric additive is poly(vinyl alcohol) or a copolymer thereof, it can have a number average molecular weight in the range of at least about 1,000 and at most about 1,000,000, as determined by gel permeation chromatography using a polystyrene standard. Similarly, when the polymeric additive is a modified poly(acrylic acid) or a copolymer thereof, its number average molecular weight can be at least about 1,000 and at most about 20,000,000, as determined by the same method. Any of the classes of polymeric additives contained in the polyurethane fiber of the invention and used in the process of the invention can have a Brookfield viscosity at 20° C. in the range of at least about 200 centiPoise and at most about 10,000 Poise as a 5 wt % solution in DMAc, based on the weight of the solution. The solution viscosity of the polymeric additive typically rises as the number average molecular weight rises.

The content of the polymeric additive in the elastomeric polyurethane fiber is at least about 0.5 wt % and at most about 50 wt %, preferably least about 1 wt % and at most about 30 wt % based on the weight of the polyurethane fiber, for good spinnability, heat set, whiteness retention, and moisture absorption-desorption. As the polymeric additive solution viscosity and molecular weight decrease, a higher weight percent of the additive can be present in the fiber and used in the process of the invention.

When the polymeric additive is poly(vinyl alcohol) (“PVA”) or a copolymer thereof, it can be prepared by hydrolyzing to hydroxyl groups some of the acetyl groups in poly(vinyl acetate) or a copolymer thereof. After such hydrolysis, at least about 1 mole percent and at most about 99 mole percent, preferably at least about 10 mole percent and at most about 90 mole percent of the repeat units derived from vinyl acetate have hydroxyl groups. The poly(vinyl alcohol) copolymer can comprise repeat units derived from ethylene, alkyl methacrylate(s), vinyl sulfonate, vinyl acetate, styrene sulfonic acid, and the like. Such a polymeric additive can be for example poly(vinyl alcohol-co-vinyl acetate-co-vinyl sulfonate), poly(vinyl alcohol-co-vinyl acetate), poly(vinyl alcohol-co-vinyl phosphate), poly(vinyl alcohol-co-vinyl acetate-co-ethylene), and poly(vinyl alcohol-co-vinyl acetate-co-alkyl methacrylate) wherein the alkyl moiety has one to three carbons. Poly(vinyl alcohol-co-vinyl acetate-co-vinyl sulfonate) is preferred.

In the modified poly(acrylic acid) additive or its copolymer, at least about 50 mole % of the repeat units can be derived from acrylic acid and can have the following general formula:

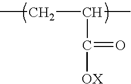

wherein X is acidic hydrogen in less than 60 mole percent of the repeat units, the acidic hydrogens in at least about 40 mole percent of the the repeat units derived from acrylic acid having been replaced with substantially non-acidic moieties, for example alkali metal ion, ammonium, alkylammonium, dialkylammonium, and alkyl moieties wherein the alkyls have 1 to 3 carbon atoms. Comonomers in such polymeric additives can include maleic acid, acrylamide, N,N-dialkylacrylamide, styrene sulfonic acid, ethylene sulfonic acid, methacrylic acid, sodium maleate, sodium styrene sulfonate, methacrylate esters, ethylene, dimethylaminoethyl acrylate, dimethylaminoethyl methacrylate, dialkylammonium acrylate (for example diethylammonium acrylate generated by addition of excess diethylamine chain terminator to the polyurethane spinning solution followed by addition of poly(acrylic acid)), dimethylammonium diallyl chloride and the like. Examples of such modified poly(acrylic acid) additives include poly(dialkylammonium acrylate), poly(sodium acrylate), poly(methyl acrylate), poly(potassium acrylate), poly(dialkylammonium acrylate), poly(sodium acrylate-co-acrylamide), poly(sodium acrylate-co-sodium styrene sulfonate), poly(ammonium acrylate), poly(alkylammonium acrylate-co-N-alkylacrylamide), poly(acrylic acid-co-sodium acrylate-co-acrylamide), and the like. Poly(dialkylammonium acrylate), poly(alkylammonium acrylate), poly(sodium acrylate-co-acrylamide), and poly(sodium acrylate-co-sodium styrene sulfonate) are preferred. The alkyl moieties in such polymers can each have one to three carbons.

Elastomeric polyurethane fiber can be prepared by contacting a polymeric glycol (for example a polyether glycol, a polyester glycol, or a polycarbonate glycol) with a diisocyanate and a difunctional chain extender and spinning the resulting polyurethane.

Useful polyether glycols include, for example, poly(tetramethyleneether glycol, poly(1,2-propyleneether)glycol, poly(tetramethyleneether-co-3-methyl-tetramethyleneether)glycol, and poly(tetramethyleneether-co-2,3-dimethyl-tetramethyleneether)glycol, and the like. Useful polyester glycols include poly-ε-caprolactone diol and hydroxy-terminated reaction products of diols such as ethylene glycol, 1,3-propane diol, 1,4-butane diol, 1,6-hexane diol, 2,2-dimethyl-1,3-propane diol, 3-methyl-1,5-pentane diol, and mixtures thereof with dicarboxylic acids such as adipic acid, 1,9-nonanedioic acid, and 1,12-dodecanedioic acid, and the like. Useful polycarbonate glycols include poly(pentane-1,5-carbonate)diol, poly(hexane-1,6-carbonate)diol, and the like. Such glycols can have a number-average molecular weight of at least 1,000 and at most 8,000, preferably at least 1,800 and at most 6,000.

Useful diisocyanates include 4-methyl-1,3-phenylene diisocyanate, 1-isocyanato-4-[(4-isocyanatophenyl)methyl]benzene, mixtures of 1-isocyanato-4-[(4-isocyanatophenyl)methyl]benzene and 1-isocyanato-2-[(4-isocyanatophenyl)methyl]benzene, 1,4-diisocyanatobenzene, 1,3-diisocyanatoxylylene, 1,4-diisocyanatoxylylene, 2,6-napthalene diisocyanate, 5-isocyanato-1-(isocyanatomethyl)-1,3,3-trimethylcyclohexane, 1,1′-methylenebis(4-isocyanatocyclohexane), 2,4-diisocyanato-1-methylcyclohexane, 2,6-diisocyanato-1-methylcyclohexane, octahydro 1,5-naphthalene diisocyanate, 1,4-diisocyanatocyclohexane, bis(isocyanatomethyl)cyclohexanes, mixtures thereof, and the like.

Useful diamine chain extenders include ethylene diamine, 1,2-propane diamine, 1,3-propane diamine, 1,6-hexamethylene diamine, 1,3-xylylenediamine, p-phenylene diamine, p-xylylene diamine, m-xylylene diamine, p,p′-methylene dianiline, bis(4-aminophenyl)phosphine oxide, N-methylbis(3-aminopropyl)amine, 1,4-cyclohexanediamine, 1,3-cyclohexanediamine, 2-methyl-1,5-pentanediamine, 1,3-pentanediamine, mixtures thereof, and the like. Useful diol chain extenders include ethylene glycol, 1,3-propane diol, 1,2-propane diol, 2,2-dimethyl-1,3-propane diol, 1,4-butane diol, 3-methyl-1,5-pentane diol, 1,6-hexane diol, bis(2-hydroxyethylene terephthalate), 1,4-bis(β-hydroxyethoxy)benzene, N-methylbis(2-hydroxypropyl)amine, mixtures thereof, and the like.

When diol-extended polyurethanes are to be made, it can be advantageous to use one or more polymerization catalysts. Typical amine catalysts include, for example, N,N-dimethylcyclohexylamine, N,N-dimethylbenzylamine, triethylamine, N-methylmorpholine, N-ethylmorpholine, N,N,N′,N′-tetramethylethylene diamine, N,N,N′,N′-tetramethyl-1,3-propane diamine, N,N,N′,N′-tetramethylhexane diamine, bis-2-dimethylamino ethyl ether, N,N,N′,N′,N″-pentamethyldiethylene triamine, tetramethyl guanidine, triethylene diamine, N,N′-dimethyl piperazine, N-methyl-N′-dimethylamino ethyl-piperazine, N-(2-dimethylamino ethyl) morpholine, 1-methyl imidazole, 1,2-dimethyl imidazole, N,N-dimethylamino ethanol, N,N,N′-trimethylamino ethyl ethanol amine, N-methyl-N′-2-hydroxy ethyl (piperazine, 2,4,6-tris(dimethylamino methyl) phenol, N,N-dimethyamino hexanol, triethanol amine and the like. Typical organometallic polymerization catalysts include tin octanoate, dibutyltin dilaurate, dibutyl lead octanoate, and the like.

In order to control the molecular weight of the polyurethane, a small amount of a monofunctional chain terminator can be used, for example diethylamine, diisopropyl amine, ethylmethyl amine, diethyl amine, methylpropyl amine, isopropylmethyl amine, diisopropyl amine, butylmethyl amine, isobutylmethyl amine, isopentylmethyl amine, dibutyl amine, diamyl amine, ethanol, propanol, butanol, hexanol, n-pentylamine, n-hexylamine, cyclohexylamine, n-heptylamine, methylcyclohexylamines (for example 1-amino-3-methylcylohexane, 1-amino-2-methylcyclohexane, and 1-amino-3,3,5-trimethylcyclohexane), n-dodecylamine, 2-aminonorbomane, 1-adamantanamine, and mixtures thereof.

As long as the advantages of the present invention are not deleteriously affected, small amount of ingredients of greater than difunctionality may be used, for example diethylenetriamine and the like.

The polyurethane of which the elastomeric polyurethane fiber of the invention is comprised and which is prepared and spun in the process of the invention can have a number average molecular weight of at least 40,000 and at most 150,000, as measured by gel permeation chromatographic analysis using a polystyrene standard. The elastomeric polyurethane fiber of the invention can have a ‘high-side’ melting point of at least 200° C. and at most 260° C., as determined by ‘second pass’ differential scanning calorimetry.

The polyurethane fiber can contain additional stabilizers, pigments and the like, provided such additives to not detract from the benefits of the invention. Among such additives are benzotriazole-based stabilizers, ultraviolet light absorbers, other light resistance agents, antioxidants, anti-tack agents, lubricants such as mineral oil and silicone oils, antistatic agents and the like. Other examples of additives include hindered phenolic stabilizers such as 2,6-di-t-butyl-4-methylphenol, hindered amine stabilizers, inorganic pigments such as titanium oxide, zinc oxide, carbon black and the like, metal salts such as magnesium stearate and barium sulfate, hydrotalcite, mixtures of huntite and hydromagnesite, bactericides containing silver, zinc, or compounds thereof, deodorants, a variety of anti-static agents, phosphoric acids, and so on.

Dry-spinning or wet-spinning (herein collectively ‘solution spinning’) or melt-spinning can be used to make the polyurethane fiber. To make polyurethanes for melt-spinning, either melt-polymerization or solution polymerization can be used, and the polymerization can be carried out in one step or two steps.

When the process of the invention comprises a solution-spinning, step (which is preferred), a two-step solution polymerization process can be used. In this case, the polymeric glycol is first contacted with the diisocyanate to form a “capped glycol”, which is a mixture of isocyanate-terminated glycol and unreacted diisocyanate. The mole ratio (“capping ratio”) of diisocyanate to glycol can be about 1.5 to 4.5. The capped glycol is then dissolved in a solvent, for example dimethylacetamide (“DMAc”), dimethylformamide, dimethylsulfoxide, N-methyl-pyrrolidone, or the like. At least one chain extender and optionally a small amount of chain terminator are reacted with the capped glycol in solution to form a polyurethane(urea) solution. (For polyurethanes, a one-step solution polymerization process can also be used, in which the polymeric glycol, diisocyanate, and at least one diol chain extender are contacted with each other in the solvent substantially simultaneously.) The polymeric stabilizer selected from the group consisting of poly(vinyl alcohol), modified poly(acrylic acid), and copolymers thereof is then added. Any suitable apparatus can be used to mix the polymeric additive into the polyurethane solution, for example a static mixer, an agitator, a homogenizer, or a twin screw extruder; the additive can be added as a solution or a dispersion for greater uniformity of mixing.

The effect of adding the polymeric additive to the polyurethane solution can be tested on a small scale. Depending on the amount used, addition of a (co)poly(acrylic acid) can increase the solution viscosity more than expected or desired, in which case excess chain terminator can be added to the polyurethane solution before adding the (co)poly(acrylic acid). The amount of chain terminator added, and the amount of acidic hydrogens replaced on the acrylic acid-derived repeat units, can be at least about 40 mole %, based on the moles of repeat units derived from acrylic acid in the (co)poly(acrylic acid). For example, adding excess diethylamine chain extender to the polyurethane solution before adding poly(acrylic acid) avoids excessive increases in solution viscosity. It is believed that the poly(acrylic acid) is modified and that poly(diethylammonium acrylate-co-acrylic acid) is formed. It is also believed that some repeat units formally derived from N,N-diethylacrylamide are generated.

The resulting spinning solution, optionally containing other additives, can then be spun through a spinneret into a heated column in which the solvent evaporates from the polymer to form the polyurethane fiber. After leaving the heated column, the fiber is collected, for example by passing it around a feed (“Godet”) roll and then winding it up at a speed of at least 450 m/min and at a feed roll:winder speed ratio of at least 1:1.15 and at most 1:1.65, preferably at most 1:1.40 and more preferably at most 1:1.35.

Set, stress relaxation, tensile strength, and elongation-to-break of the polyurethane fiber made in the Examples were measured with an Instron 4502 tensile tester. A 5 cm (length L1) fiber sample was subjected to 5 stretch-and-relax cycles to 300% elongation at a speed of 50 cm/min. On the fifth stretch cycle the stress (G1) was measured at 300% elongation, the sample was held at 300% elongation for 30 seconds, and the stress (G2) was again measured. Then the sample was allowed to relax until it reached a stress of 0, at which point its length (L2) was again measured. On a sixth cycle, the sample was extended until it broke, and the stress (G3) at the break and the sample length (L3) at the break were measured. The sample's properties were calculated according to the following equations:

Strength, g=G3

Stress Relaxation, %=100×(G1−G2)/G1

Set, %=100×(L2−L1)/L1

Elongation at break, %=100×(L3−L1)/L1

Heat set efficiency was measured as follows. A polyurethane fiber sample was exposed in a relaxed condition to 100° C. steam for 10 minutes and then, while still relaxed, to boiling water for 2 hours, after which it was dried for 1 day at room temperature. The sample yarn (length=L5) was then stretched 100% and exposed to 115° C. steam for 1 minute. At the same stretched length, the sample was subjected to dry heat at 130° C. and then kept at the same length for 1 day at room temperature. Then, the sample was allowed to relax, and its length (L6) was measured. Heat set efficiency was calculated from the following equation:

Heat Set Efficiency, %=100×(L6−L5)/L5

As a measure of the moisture retention of the polyurethane fiber, a moisture absorption-desorption coefficient, ΔMR, was determined on knit tube samples weighing about 1 gram each which had been equilibrated for 24 hours under various conditions in a constant temperature, constant relative humidity (“RH”) oven (Tabai Co. oven model PR-2G). Each sample was thoroughly dried at 105° C. for 2 hours in a hot-air oven and cooled for 30 minutes in a desiccator to establish its ‘absolute dry weight’, and then it was exposed to conditions of higher temperature and humidity. The moisture absorption-desorption coefficient was calculated from the following equation:

ΔMR, %=MR₂−MR₁

wherein:

MR₂=100×(W_{30×90}−ADW)/ADW;

MR₁=100×(W_{20×65}−ADW)/ADW;

W_{30×90} is the weight of the sample after 24 hours' equilibration at 30° C. and 90% RH;

W_{20×65} is the weight of the sample after 24 hours' equilibration at 20° C. and 65%RH; and

ADW is the absolute dry weight.

The coefficient ΔMR represents the difference in moisture absorption between in-clothing conditions (30° C. and 90% RH, similar to participation. in light to medium effort) and outdoor conditions (20° C. and 65% RH) and indicates the release of moisture from the clothing to the outside atmosphere. The greater the ΔMR, the greater the comfort experienced by a wearer.

To measure whiteness retention after exposure to ultraviolet light, 10 grams of non-scoured polyurethane fiber was wound around a stainless steel sheet at low tension to form a layer of about 0.3 cm thickness and exposed for 25 hours to ultraviolet (“UV”) light (carbon arc) at 63° C. and 60% RH in a Sunshine Weather Meter (Wel-Sun-HCH Model B, sold by Suga Shikenki K.K., Shinjuku-Ku, Tokyo, Japan. To measure whiteness retention after exposure to NO₂, similarly prepared samples were exposed for 20 hours to 10 ppm NO₂ gas in air in a Scott Controlled Atmosphere tester (made by Scott Research Laboratories, Inc.) at 40° C. and 60% RH. To measure whiteness retention after exposure to chlorine, a polyurethane fiber sample of about 10 grams was wound around a Teflon® sheet to prepare a sample card, which was then soaked for 30 minutes in an aqueous solution of 500 ppm chlorine (“Haita” bleach from Kao Corporation) at a temperature of 40±2° C., followed by rinsing for 10 minutes with water and air drying at room temperature. Differences S between “b” values (“Db”) before and after exposure to UV, NO₂, or chlorine were measured with a Model D-25-9000 Colormaster differential colorimeter having a Model D-29-DP-9000 signal processor (Hunter Associates Laboratory, Inc., Reston, Va.).

To determine the content of (co)poly(vinyl alcohol) or (co)poly(acrylic acid) in the elastomeric polyurethane fiber, a calibration curve was first prepared from a first sample of the fiber to be analyzed. The first 1 g sample of the fiber containing the polymeric additive was washed with n-hexane and completely dissolved in 50 ml of DMAc. Ethanol (100 ml) was very slowly added to precipitate the polymeric additive, the precipitate was filtered off and dissolved and re-precipitated, and the remaining polyurethane solution was filtered and evaporated to dryness to isolate the polyurethane from the first fiber sample. The polyurethane and polymeric additive were re-mixed in known weight ratios of 0 wt %, 1 wt %, 3wt %, 6wt %, 10 wt %, 20 wt %, and 40 wt % additive, based on total polymer weight. The mixtures were re-dissolved in DMAc, the resulting solutions were cast into films, and IR spectra of the films were taken with an AFT-IR instrument (Perkin Elmer Company). Area ratios (X) between selected bands at 1,700 cm⁻¹ to 1,800 cm⁻¹ [ν(CO)] and a 3,400 cm⁻¹ peak [ν(OH) for (co)poly(vinyl alcohol)] or a 1500-1700cm⁻¹ band [ν(CO) for (co)poly(acrylic acid)] were calculated. The calibration curve was prepared by plotting peak area ratio (X) versus (co)poly(vinyl alcohol) or (co)poly(acrylic acid) content (wt %) to obtain a slope α. A second 1 g sample of the fiber to be analyzed was washed with n-hexane, dissolved in DMAc, and cast into a film without separating the polyurethane from the additive, and its IR spectrum was measured. A similar IR peak area ratio (Xₛ) was obtained between the ν(CO) bands and the ν(OH) peak for (co)poly(vinyl alcohol) or the ν(CO) band for (co)poly(acrylic acid). The additive content was calculated according to the following formula:

Content (wt %)=α×Xₛ.

In the Tables, “Eb” represents elongation-at-break, “T” tensile strength, “SR” stress relaxation, “HSE” heat-set efficiency, “Delta MR” the Moisture Absorption-Desorption Coefficient, and “Db” delta b.

### EXAMPLE 1

Poly(tetramethylene ether)glycol of number-average molecular weight 2900 (496 grams), 1-isocyanato4-[(4-isocyanatophenyl)methyl]benzene (170 g) (diisocyanate:glycol mole ratio 3.97:1) were contacted with each other, and the resulting capped glycol was dissolved in 1333 g DMAc. Ethylene glycol (37.87 g) and 14.16 g n-butanol were reacted with the dissolved capped glycol to form a 35wt % polyurethane solution, labelled A1. Separately, a dispersion of poly(vinyl alcohol) (Gohsenol®, Nippon Gohsei Kagaku KK; number average molecular weight 500,000, degree of saponification 88, viscosity 2,200 Poise) was prepared in DMAc using a horizontal Wiley mill (A. Bachofen Company, DYNO-MIL JDL) filled with 85% zirconia beads at a flow rate of 50 g/min. The PVA dispersion was 35 wt % based on total dispersion weight and was labelled B1. A stabilizer additive mixture labelled C1 was prepared from a 2:1 weight ratio of Methacrol® 2462B ((bis(4-isocyanatocyclohexyl)methane) and N-t-butyldiethanolamine) and Methacrol® 2390 D (condensation polymer of p-cresol and divinyl benzene) (both registered trademarks of E. I. du Pont de Nemours and Company) in DMAc at a level of 35wt % additives, based on total mixture weight.

Solution A1, dispersion B1, and mixture C1 were uniformly mixed in amounts such that the final polyurethane fiber had 5 wt % PVA and 2 wt % of the stabilizer additives, based on total fiber weight. The resulting spinning solution, D1, was dry-spun at a speed ratio of 1.4 between the Godet (feed) roll and the windup and wound up at 540 m/min to obtain 200 g of a 20 decitex monofilament elastomeric polyurethane fiber. Properties of the polyurethane fiber are presented in Table 1.

The polyurethane fiber was single-covered with “Miracosmo” (22 decitex nylon yarn, manufactured by Toray K K), and the covered polyurethane fiber was used to knit pantyhose in which the covered fiber was present in every course; the pantyhose had excellent visual and tactile aesthetics. Its moisture absorption-desorption coefficient is presented in Table 1.

### EXAMPL 2

A 35 wt % dispersion of poly(vinyl alcohol) (SMR resin®, Shin-Etsu Kagaku K K; number average molecular weight 100,000; viscosity 200 Poise) was prepared in DMAC by the same method as in Example 1 and labelled B2. Solution A1, dispersion B2, and mixture C1 were uniformly mixed to obtain a spinning solution D2 at ratios such that in the final elastomeric polyurethane fiber the PVA was present at a level of 20 wt % and the stabilizer additives were present at a total level of 2 wt %, based on fiber weight. Solution D2 was dry spun at a speed ratio of 1.40 between the Godet roll and windup and wound up at 540 m/min to obtain 200 g of a 20 decitex, monofilament polyurethane fiber. The polyurethane fiber was covered and knit as in Example 1, and the resulting pantyhose had excellent visual and tactile aesthetics. Table 1 presents physical properties of the polyurethane fiber and the moisture absorption-desorption coefficient of the pantyhose.

### EXAMPLE 3

Poly(tetramethylene ether) glycol of number-average molecular weight 1800 (704 g) and 1-isocyanato-4-[(4-isocyanatophenyl)methyl]benzene (155 g) (diisocyanate:glycol mole ratio 1.58:1) were contacted with each other to form a capped glycol which was dissolved in 1625 g DMAc, chain-extended with 13.76 g ethylenediamine, and chain-terminated with 2.01 g diethylamine to give a solution (labelled A2) that was 35 wt % in polyurethaneurea. Then a dispersion of a sulfonic acid-modified poly(vinyl alcohol), believed to be poly(sodium allyl sulfonate-co-vinyl alcohol), (Gohseran®, Nippon Gosei Kagaku K K; number average molecular weight 20,000, degree of saponification 45, viscosity 110 Poise) in DMAc was prepared as described in Example 1 and labelled B3. Solution A2, dispersion B3, and mixture C1 were uniformly mixed to give a spinning solution D3 in a ratio such that the final elastomeric polyurethane fiber contained 30 wt % PVA and 2 wt % stabilizer additive mixture, based on fiber weight. The solution D3 was dry spun at a speed ratio of 1.20 between the Godet roll and windup and wound up at 600 m/min to give 500 g of 20 decitex multifilament polyurethane fiber. The polyurethane fiber was covered and knit as described in Example 1 to make an every-course pantyhose having excellent visual and tactile aesthetics. Polyurethane fiber and pantyhose properties are presented in Table 1.

### EXAMPL 4

Poly(tetramethylene ether) glycol of number-average molecular weight 1800 (687 g) and 1-isocyanato4-[(4-isocyanatophenyl)methyl]benzene (166 g) (diisocyanate:glycol mole ratio 1.74:1) were contacted with each other to make a capped glycol which was dissolved in 1625 g DMAc, chain-extended with 15.12 g ethylene diamine and 3.78 g 1,3-cyclohexanediamine (80/20 molar ratio), and chain-terminated with 2.68 g diethylamine to make polyurethane solution A3, which was 35 wt % polyurethane, based on total solution weight. Solution A3, dispersion B3, and mixture C1 were uniformly mixed to obtain spinning solution D4 at ratios such that the final elastomeric polyurethane fiber contained 35 wt % PVA and 2 wt % stabilizer additives, based on fiber weight. Solution D4 was dry spun using a speed ratio of 1.30 between the Godet roll and the windup and was wound up at 600 m/min to obtain 500 g of 20 decitex multifilament polyurethane fiber having a poly(vinyl alcohol) content of 35 wt %, based on total fiber weight. The polyurethane fiber was covered and knit as in Example 1 to give pantyhose with excellent visual and tactile aesthetics. Polyurethane fiber and pantyhose properties are given in Table 1.

### COMPARATIVE EXAMPLE 1

Example 1 was repeated but without adding dispersion B1. The dry-spun monofilament elastomeric polyurethane fiber had a linear density of 18 decitex. It was covered and knit as in Example 1. Its properties and those of the pantyhose are given in Table 1.

### COMPARATIVE EXAMPLE 2

Example 3 was repeated but without dispersion B3. The resulting 20 decitex multifilament elastomeric polyurethane fiber was covered and knit as in Example 1. Its properties and those of the pantyhose are given in Table 1.

### COMPARATIVE EXAMPLE 3

Example 4 was repeated but without dispersion B3. The resulting 20 decitex multifilament elastomeric polyurethane fiber was covered and knit as in Example 1. Its properties and those of the pantyhose are given in Table 1.

TABLE 1

| | Elastomeric | | | | | | | | | |
|---|---|---|---|---|---|---|---|---|---|---|
| | Polyurethane | | | | | | | | | |
| | Fiber | | | | | Delta MR, % | | Polyurethane Fiber | | |
| | | | | | HSE, | Polyuretha | | Db values | | |
| Example | Eb, % | T, g | Set, % | SR, % | % | Fiber | Pantyhouse | UV | Nox | Cl |
| 1 | 440 | 20 | 30 | 35 | 61 | 2.0 | 4.4 | 4.4 | 3.8 | 2.9 |
| 2 | 435 | 20 | 33 | 35 | 70 | 4.0 | 4.4 | 2.6 | 2.0 | 1.6 |
| 3 | 510 | 22 | 29 | 30 | 66 | 5.4 | 4.9 | 1.8 | 1.0 | 1.9 |
| 4 | 550 | 23 | 31 | 33 | 66 | 5.1 | 5.0 | 2.2 | 1.8 | 1.2 |
| Comp. 1 | 400 | 20 | 25 | 35 | 55 | 0.4 | 2.7 | 6.4 | 6.5 | 4.2 |
| Comp. 2 | 490 | 25 | 18 | 28 | 25 | 0.6 | 2.8 | 8.5 | 8.0 | 5.7 |
| Comp. 3 | 500 | 22 | 22 | 30 | 30 | 0.4 | 2.5 | 7.2 | 8.3 | 4.4 |

The data in Table 1 shows that the elastomeric polyurethane fiber of the invention displays improved heat-set efficiencies and much higher moisture absorption-desorption coefficients while still retaining good elongation, tensile, set, and stress relaxation properties. Further, its whiteness retention after exposure to UV, NO₂, or chlorine is substantially improved over polyurethane fiber not of the invention.

### EXAMPLE 5

Example 1 was repeated, except that a 35 wt % dispersion of a poly(sodium acrylate-co-acrylamide) (Sanfloc®, a product of Sanyo Kasei Co.; sodium acrylate:acrylamide mole ratio 90:10, number average molecular weight 5,000,000, viscosity 8,000 Poise) was prepared in DMAc and labelled B4. Solution A1, dispersion B4, and mixture C1 were uniformly mixed to obtain spinning solution D5 and in amounts such that the final elastomeric polyurethane fiber had 5 wt % poly(sodium acrylate-co-acrylamide) and 2 wt % of the stabilizer additives, based on total fiber weight. Solution D5 was then dry-spun as in Example 1 to form the polyurethane fiber, whose properties are summarized in Table 1.

The elastomeric polyurethane fiber was single-covered and knit as in Example 1 to give a pantyhose with excellent visual and tactile aesthetics. Its moisture absorption-desorption coefficient is also presented in Table 1.

### EXAMPLE 6

A 35 wt % dispersion of a copolymer of sodium acrylate-sulfonic acid (Aqualice; number average molecular weight 60,000, viscosity 200 Poise; a product of Nippon Shokubai (Catalyst) K K) was prepared in DMAC by the same method as in Example 1 and labelled B5. Solution A1, dispersion B5, and mixture C1 were uniformly mixed to obtain a solution D6 and in relative amounts such that in the final elastomeric polyurethane fiber the sodium acrylate-sulfonic acid additive was 20 wt % and the stabilizer additives were 2 wt %, based on weight of fiber. Solution D6 was dry-spun as in Example 1 to give the polyurethane fiber, whose properties are summarized in Table 2.

The elastomeric polyurethane fiber was single-covered and knit as in Example 1 to give a pantyhose with excellent visual and tactile aesthetics. Its moisture absorption-desorption coefficient is presented in Table 1.

### EXAMPLE 7

Example 3 was repeated except that a fine dispersion of poly(sodium acrylate) (Aqualic®; number average molecular weight 3,500, viscosity 150 Poise; a product of Nippon Shokubai (Catalyst) K K) was prepared in DMAC using the method described in Example 1 and labelled B6. Solution A2, dispersion B6, and mixture C1 were uniformly mixed to give a spinning solution D7 and in amounts such that the final fiber had 25 wt % poly(sodium acrylate) and 2 wt % stabilizer additives, based on total weight of fiber. Solution D7 was then dry-spun as described in Example 3 to give the elastomeric polyurethane fiber, whose properties are presented in Table 2. The polyurethane fiber was covered and knit as described in Example 1 to give pantyhose with excellent appearance and tactile aesthetics and whose moisture absorption-desorption coefficient ΔMR is also given in Table 2.

### EXAMPLE 8

Example 4 was repeated, except that dispersion B6 was used in an amount such that 30 wt % of poly(sodium acrylate) was present in the final polyurethane fiber, based on weight of fiber, to give a spinning solution D8 which was then dry-spun as described in Example 7 to give the polyurethane fiber, whose properties are also given in Table 2. The elastomeric polyurethane fiber was covered and knit as described in Example 1 to give a pantyhose whose visual and tactile aesthetics were excellent and whose moisture absorption-desorption coefficient ΔMR is presented in Table 2.

### COMPARATIVE EXAMPL 4

Example 5 was repeated but without adding dispersion B4. The dry-spun monofilament elastomeric polyurethane fiber had a linear density of 18 decitex. It was covered and knit as in Example 1, and its properties and those of the pantyhose made from it are given in Table 2.

### COMPARATIVE EXAMPLE 5

Example 7 was repeated but without adding dispersion B6. The properties of the resulting elastomeric polyurethane fiber and of pantyhose knit from the covered polyurethane fiber are given in Table 2.

### COMPARATIVE EXAMPLE 6

Example 8 was repeated but without adding dispersion B6. The properties of the resulting elastomeric polyurethane fiber and of pantyhose knit from the covered polyurethane fiber are given in Table 2.

TABLE 2

| | Elastomeric | | | | | | | | |
|---|---|---|---|---|---|---|---|---|---|
| | Polyurethane | | | | | | | | |
| | Fiber | | | | | Delta MR, % | | Polyurethane | |
| | | | | | HSE | Polyuretha | | Fiber Db | |
| Example | Eb, % | T, g | Set, % | SR, % | % | Fiber | Pantyhose | UV | NOx |
| 5 | 420 | 22 | 29 | 34 | 59 | 1.8 | 3.9 | 5.0 | 3.2 |
| 6 | 400 | 26 | 33 | 35 | 70 | 4.6 | 4.4 | 3.9 | 2.1 |
| 7 | 499 | 26 | 25 | 30 | 64 | 4.4 | 4.9 | 3.3 | 4.4 |
| 8 | 510 | 25 | 28 | 34 | 70 | 5.1 | 4.7 | 2.8 | 3.0 |
| Comp. 4 | 400 | 20 | 25 | 35 | 55 | 0.4 | 2.7 | 6.4 | 6.5 |
| Comp. 5 | 490 | 25 | 18 | 28 | 25 | 0.6 | 2.8 | 8.5 | 8.0 |
| Comp. 6 | 500 | 22 | 22 | 30 | 30 | 0.4 | 2.5 | 7.2 | 8.3 |

The data in Table 2 show that the elastomeric polyurethane fiber of the invention has significantly improved heat-set efficiency and whiteness retention compared to polyurethane fiber not of the invention, without sacrifice of physical properties, and pantyhose made with polyurethane fiber of the invention has a much-improved moisture absorption-desorption coefficient, compared to pantyhose knit from polyurethane fiber not of the invention.

1. An elastomeric polyurethane fiber containing a polymeric additive having repeat units and selected from the group consisting of:
poly(vinyl alcohol) and copolymers thereof, wherein at least about 1 mole % of the repeat units derived from vinyl acetate have hydroxyl groups, and at most about 99 mole % of the repeat units derived from vinyl acetate have hydroxyl groups; and
modified poly(acrylic acid) and copolymers thereof, wherein acidic hydrogens in at least about 40 mole % of the repeat units derived from acrylic acid have been replaced with substantially non-acidic moieties; wherein the additive is present in the fiber at a level of at least about 0.5 wt % based on the weight of the fiber, and the additive is present in the fiber at a level of at most about 50 wt %, based on the weight of the fiber.

2. The fiber of claim 1 wherein the polymeric additive is selected from the group consisting of poly(vinyl alcohol) and copolymers thereof, the polymeric additive has a number average molecular weight of at least about 1,000, and the polymeric additive has a number average molecular weight of at most about 1,000,000.

3. The fiber of claim 1 wherein:
the polymeric additive is selected from the group consisting of poly(vinyl alcohol-co-vinyl acetate-co-vinyl sulfonate), poly(vinyl alcohol-co-vinyl acetate), poly(vinyl alcohol-co-vinyl phosphate), poly(vinyl alcohol-co-vinyl acetate-co-ethylene), and poly(vinyl alcohol-co-vinyl acetate-co-alkyl methacrylate) wherein the alkyl moiety has one to three carbons;
at least about 10 mole % of the repeat units derived from vinyl acetate have hydroxyl groups; and
at most about 90 mole % of the repeat units derived from vinyl acetate have hydroxyl groups.

4. The fiber of claim 1 wherein the polymeric additive is selected from the group consisting of modified poly(acrylic acid) and copolymers thereof, the polymeric additive has a number average molecular weight of at least about 1,000, the polymeric additive has a number average molecular weight of at most about 20,000,000.

5. The fiber of claim 1 wherein the polymeric additive is a modified poly(acrylic acid) or copolymer thereof selected from the group consisting of poly(sodium acrylate), poly(dialkylammonium acrylate) wherein the alkyl moieties each have one to three carbons, poly(alkylammonium acrylate) wherein the alkyl moiety has one to three carbons, poly(sodium acrylate-co-acrylamide), and poly(sodium acrylate-co-sodium styrene sulfonate) wherein at least 50 mole percent of the repeat units are derived from acrylic acid.

6. The fiber of claim 1 wherein, at 20° C. as a 5 wt % solution in dimethylacetamide, the polymeric additive has a viscosity of at least about 200 centipoise and the polymeric additive has a viscosity of at most about 10,000 poise.

7. The fiber of claim 1 wherein the polymeric additive is poly(vinyl alcohol-co-vinyl acetate-co-vinyl sulfonate), the polymeric additive is present at a level of at least about 1 wt % based on fiber weight, and the polymeric additive is present at a level of at most about 30 wt % based on. fiber weight.

8. A process for making the elastomeric polyurethane fiber of claim 1 comprising the steps of:
a) contacting a polymeric glycol with a diisocyanate to form a capped glycol;
b) dissolving the capped glycol in a solvent;
c) reacting the dissolved capped glycol with a chain extender to form the polyurethane in solution;
d) adding the polymeric additive to the polyurethane solution;
e) solution-spinning the polyurethane solution to form the fiber; and
f) collecting the fiber.

9. The process of claim 8 wherein:
after step c) is inserted another step:
c1) adding monoamine chain terminator to the polyurethane solution in an amount of at least about 40 mole % of the acid repeat units of the polymeric additive; and
the polymeric additive is selected from the group consisting of poly(acrylic acid) and copolymers thereof.

10. The process of claim 8 wherein the polymeric additive is selected from the group consisting of poly(vinyl alcohol) and copolymers thereof.
